(19) United States
(12) Patent Application Publication
(10) Pub. No.: US 2023/0275476 A1
(43) Pub. Date: Aug. 31, 2023

(54) AXIAL FLUX ELECTRIC MACHINE INCLUDING HYBRID STATOR CORE WITH SOFT MAGNETIC COMPOSITE (SMC) COMPONENTS AND LAMINATE COMPONENT HAVING LOCKING MECHANISM TO SECURE THE SMC COMPONENTS

(71) Applicant: GM Global Technology Operations LLC, Detroit, MI (US)

(72) Inventors: Jian YAO, Shanghai (CN); Chengwu DUAN, Shanghai (CN)

(21) Appl. No.: 17/724,588

(22) Filed: Apr. 20, 2022

(30) Foreign Application Priority Data
Feb. 28, 2022 (CN) 202210186487.1

(51) Int. Cl. H02K 1/18; H02K 1/2713

(52) U.S. Cl. CPC H02K 1/182; H02K 1/2713; H02K 7/003

(57) ABSTRACT

A hybrid stator core for an axial flux electric machine is described herein. The hybrid stator core includes a laminated component and at least one soft magnetic composite (SMC) component. The laminated component includes a first block section, a first tab, and a second tab, the first block section having a first end, a second end opposite the first end, a first side surface extending between the first and second ends, and a second side surface opposite the first side surface. The first tab projects from the first side surface adjacent to the first end of the first block section. The second tab projects from the first side surface adjacent to the second end of the first block section. The at least SMC component is configured to abut the first side surface of the first block section. The first and second tabs are configured to hold the at least one SMC component therebetween.

### CROSS-REFERENCE TO RELATED APPLICATIONS

This application claims the benefit of Chinese Patent Application No. 202210186487.1, filed on Feb. 28, 2022. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to axial flux electric machines including a hybrid stator core with soft magnetic composite (SMC) components and a laminate component having a locking mechanism to secure the SMC components.

Generally, the term electric machine covers electric motors and electric generators. Electric motors convert electrical energy into mechanical work by the production of torque, while electric generators convert mechanical work to electrical energy. Electric vehicles, including battery electric vehicles, hybrid vehicles and fuel cell vehicles, employ electric machines, such as induction motors and permanent magnet motors, to propel the vehicles when acting as an electric motor, as well as to capture braking energy when acting as an electric generator. Motors will be referred to herein; however, it will be understood that such principles also equally apply to generators. Generally, the electric motor includes a rotor that rotates during operation and a stator that is stationary. The rotor may contain a plurality of permanent magnets and rotates relative to the fixed stator. The rotor is connected to a rotor shaft that also rotates with the rotor. The rotor, including the permanent magnets, is separated from the stator by a predetermined air gap. The stator includes conductors in the form of windings. When electrical energy is applied through the windings, a magnetic field is generated. When electric energy is fed into the windings of the stator, the power is transferred by magnetic flux that acts on the permanent magnets in the rotor. In this manner, mechanical power can be transferred to the rotating rotor shaft. In an electric vehicle, the rotor thus transmits torque via the rotating shaft to the drive wheels of the vehicle.

Two common types of electric motors include radial flux and axial flux type motors. In a radial flux motor, the rotor and stator are typically situated in a concentric or nested configuration, so that when a stator is energized, it creates a magnetic flux that extends radially from the stator to the rotor. Thus, the windings in the stator are typically arranged parallel to an axis of rotation so that a magnetic field is generated that is oriented in the radial direction from the axis of rotation (along the rotor shaft).

In an axial flux motor, a magnetic field parallel to an axis of rotation is produced by the windings in the stator, so the magnetic flux extends parallel to an axis of rotation (parallel to the rotor shaft). In certain applications, axial flux motors are desirable because they are relatively lightweight, generate increased power, and have a compact size as compared to radial flux motors.

### SUMMARY

A hybrid stator core for an axial flux electric machine is described herein. In one example, the hybrid stator core includes a laminated component and at least one soft magnetic composite (SMC) component. The laminated component includes a first block section, a first tab, and a second tab, the first block section having a first end, a second end opposite the first end, a first side surface extending between the first and second ends, and a second side surface opposite the first side surface. The first tab projects from the first side surface adjacent to the first end of the first block section. The second tab projects from the first side surface adjacent to the second end of the first block section. The at least SMC component is configured to abut the first side surface of the first block section. The first and second tabs are configured to hold the at least one SMC component therebetween.

In one aspect, the at least one SMC component includes a first SMC component and a second SMC component. The first SMC component is configured to abut the first side surface of the first block section adjacent to the first end thereof. The second SMC component is configured to abut the first side surface of the first block section adjacent to the second end thereof.

In one aspect, the first SMC component defines a first groove configured to receive the first tab, and the second SMC component defines a second groove configured to receive the second tab.

In one aspect, the laminated component further includes a third tab and a fourth tab, and the hybrid stator core further includes a third SMC component and a fourth SMC component. The third tab projects from the second side surface of the first block section adjacent to the first end thereof. The fourth tab projects from the second side surface adjacent to the second end thereof. The third SMC component is configured to abut the second side surface of the first block section adjacent to the first end thereof. The fourth SMC component is configured to abut the second side surface of the first block section adjacent to the second end thereof. The third and fourth tabs are configured to hold the third and fourth SMC components therebetween.

In one aspect, the hybrid stator core has a trapezoidal cross section within a plane perpendicular to the first and second side surfaces of the first block section.

In one aspect, the laminated component further includes a second block section, a third tab, and a fourth tab. The second block section adjoins the first block section and has a first end, a second end opposite the first end, and a first side surface extending between the first and second ends. The third tab projects from the first side surface adjacent to the first end of the second block section. The fourth tab projects from the first side surface adjacent to the second end of the second block section. The third and fourth tabs are configured to hold the at least one SMC component therebetween.

In one aspect, the first block section has a first width between the first and second ends thereof, the second block section is disposed above the first block section and has a second width between the first and second ends thereof, and the second width is greater than the first width.

Another example of a hybrid stator core for an axial flux electric machine is described herein. The hybrid stator core includes a laminated component and at least one SMC component. The laminated component includes a first block section, a second block section, a first tab, and a second tab. Each of the first and second block sections having a first end, a second end opposite the first end, a first side surface extending between the first and second ends, and a second side surface opposite the first side surface. The first tab projects from the first side surface of the first block section adjacent to the first end thereof. The second tab projects from the first side surface of the second block section adjacent to the second end thereof. The at least one SMC component is configured to abut the first side surfaces of the first and second block sections. The first and second tabs are configured to hold the at least one SMC component therebetween.

In one aspect, the at least one SMC component includes a first SMC component and a second SMC component, the first SMC component is configured to abut the first side surface of the first block section adjacent to the first end thereof, and the second SMC component is configured to abut the first side surface of the first block section adjacent to the second end thereof.

In one aspect, the first SMC component defines a first groove configured to receive the first tab, and the second SMC component defines a second groove configured to receive the second tab.

In one aspect, the laminated component further includes a third tab and a fourth tab, and the hybrid stator core further includes a third SMC component and a fourth SMC component. The third tab projects from the second side surface of one of the first and second block sections adjacent to the first end thereof. The second tab projects from the second side surface of the other one of the first and second block sections adjacent to the second end thereof. The third SMC component is configured to abut the second side surfaces of the first and second block sections adjacent to the first ends thereof. The fourth SMC component is configured to abut the second side surfaces of the first and second block sections adjacent to the second ends thereof. The third and fourth tabs are configured to hold the third and fourth SMC components therebetween.

In one aspect, the laminated component is free of any tab projecting from the first side surface of the first block section adjacent to the second end thereof, and the laminated component is free of any tab projecting from the first side surface of the second block section adjacent to the first end thereof.

In one aspect, the first block section has a first width between the first and second ends thereof, the second block section is disposed above the first block section and has a second width between the first and second ends thereof, and the second width is greater than the first width.

In one aspect, the laminated component further includes a third block section disposed below the first block section and a fourth block section disposed above the second block section. Each of the third and fourth block sections has a first end and a second end opposite the first end. The first ends of the first, second, third, and fourth block sections are disposed within a first common plane. The second ends of the first, second, third, and fourth block sections are disposed within a second common plane. The third block section has a third width between the first and second ends thereof. The fourth block section has a fourth width between the first and second ends thereof. The third width is less than the first width. The fourth width is greater than the second width.

Another example of a hybrid stator core for an axial flux electric machine is described herein. The hybrid stator core includes a laminated component, a first SMC component, a second SMC component, a third SMC component, and a fourth SMC component. The laminated component includes a first block section, a second block section, a first tab, a second tab, a third tab, and a fourth tab. Each of the first and second block sections has a first end, a second end opposite the first end, a first side surface, and a second side surface opposite the first side surface. The first and second side surfaces extend between the first and second ends. The first tab projects from the first side surface of one of the first and second block sections adjacent to the first end thereof. The second tab projects from the first side surface of one of the first and second block sections adjacent to the second end thereof. The third tab projects from the second side surface of one of the first and second block sections adjacent to the first end thereof. The fourth tab projects from the second side surface of one of the first and second block sections adjacent to the second end thereof. The first SMC component is configured to abut the first side surfaces of the first and second block sections adjacent to the first ends thereof. The second SMC component is configured to abut the first side surfaces of the first and second block sections adjacent to the second ends thereof. The first and second tabs are configured to hold the first and second SMC components therebetween. The third SMC component is configured to abut the second side surfaces of the first and second block sections adjacent to the first ends thereof. The fourth SMC component is configured to abut the second side surfaces of the first and second block sections adjacent to the second ends thereof. The third and fourth tabs are configured to hold the third and fourth SMC components therebetween.

In one aspect, the first tab projects from the first side surface of the first block section adjacent to the first end thereof, the second tab projects from the first side surface of the first block section adjacent to the second end thereof, the third tab projects from the second side surface of the first block section adjacent to the first end thereof, and the fourth tab projects from the second side surface of the first block section adjacent to the second end thereof.

In one aspect, the first tab projects from the first side surface of the first block section adjacent to the first end thereof, the second tab projects from the first side surface of the second block section adjacent to the second end thereof, the third tab projects from the second side surface of the first block section adjacent to the first end thereof, the fourth tab projects from the second side surface of the second block section adjacent to the second end thereof, and the laminated component is free of any tab projecting any one of (i) the first side surface of the first block section adjacent to the second end thereof, (ii) the first side surface of the second block section adjacent to the first end thereof, (iii) the first side surface of the first block section adjacent to the second end thereof, and (iv) the first side surface of the second block section adjacent to the first end thereof.

In one aspect, the first SMC component defines a first groove configured to receive the first tab and a second groove configured to receive the third tab, and the second SMC component defines a third groove configured to receive the second tab and a fourth groove configured to receive the fourth tab.

In one aspect, the laminated component further includes a third block section disposed below the first block section and a fourth block section disposed above the second block section. Each of the third and fourth block sections has a first end and a second end opposite the first end. The first ends of the first, second, third, and fourth block sections are disposed within a first common plane. The second ends of the first, second, third, and fourth block sections are disposed within a second common plane. The first block section has a first width between the first and second ends thereof. The second block section is disposed above the first block section and has a second width between the first and second ends thereof. The third block section has a third width between the first and second ends thereof. The fourth block section has a fourth width between the first and second ends thereof. The second width is greater than the first width, the third width is less than the first width, and the fourth width is greater than the second width.

In one aspect, each of the first, second, third, and fourth SMC sections has a stepped surface and an angled surface opposite the stepped surface. The stepped surfaces of the first and second SMC sections are configured to abut the first side surfaces of the first, second, third, and fourth block sections. The stepped surfaces of the third and fourth SMC sections are configured to abut the second side surfaces of the first, second, third, and fourth block sections. A bottom surface of the third block section, a top surface of the fourth block section, and the angled surfaces of the first, second, third, and fourth SMC sections form a perimeter of the hybrid stator core configured to have a winding wrapped thereabout. The perimeter of the hybrid stator core has a trapezoidal shape.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an example of an axial flux motor including a plurality of hybrid stator cores according to the principles of the present disclosure, each stator core including a laminate component and a plurality of soft magnetic composite (SMC) components;

FIG. 2 is a perspective view of one of the hybrid stator cores of FIG. 1;

FIG. 3 is an exploded perspective view of the hybrid stator core shown in FIG. 1 with top and bottom block sections of the laminate component hidden to better illustrate a locking mechanism of the laminate component; and

FIG. 4 is an exploded perspective view of another example of a hybrid stator core according to the principles of the present disclosure.

In the drawings, reference numbers may be reused to identify similar and/or identical elements.

### DETAILED DESCRIPTION

A stator of an axial flux motor typically includes a plurality of stator cores that are circumferentially arranged about a rotor shaft. Two types of stator cores include laminated stator cores and soft magnetic composite (SMC) stator cores. Laminated stator cores include sheets or layers of electrical steel that are pressed into a desired shape. Laminated stator cores may be difficult to manufacture into complex shapes, such as trapezoidal shapes, which improve the functionality of the stator. SMC stator cores are made of ferromagnetic or iron powder and other powders that are pressed into a desired shape and heated. While SMC stator cores can be formed into a variety of shapes, such stator cores can generate undesirable eddy currents and an increased level of hysteresis in an axial flux motor.

A hybrid stator core includes a laminated component and one or more SMC components. The laminated component typically forms an interior portion of the hybrid stator core, while the SMC components form an exterior portion of the hybrid stator core. The presence of the laminated component ensures that the hybrid stator core does not generate undesirable eddy currents or an increased level of hysteresis. The presence of the SMC components enables forming the hybrid stator core into a variety of complex shapes such as a trapezoidal shape. For example, the laminated component may have a simple shape formed by stacked block sections, while the SMC components may have stepped surfaces that abut the block sections and angled surfaces that form angled sides of the trapezoidal shape.

The SMC components are typically held together using adhesive. During motor operation, the hybrid stator core is subjected to high and low temperatures, and the adhesive holding the SMC components together may breakdown. In turn, the large magnetic attraction forces between the rotor and the stator may pull one of the SMC components apart from another one of the SMC components.

To address this issue, a hybrid stator core according to the present disclosure includes a laminated component having a locking mechanism that holds the SMC components together. In the examples described herein, the locking mechanism includes a pair of tabs that project from a surface of the laminated component that abuts the SMC components. The tabs hold the SMC components therebetween. In one example, both tabs in the pair project from the same block section of the laminated component adjacent to opposite ends thereof. In another example, one tab in the pair projects from one end of one block section and the other tab in the pair projects from the other end of another block section. In both examples, the SMC components define grooves that receive the tabs.

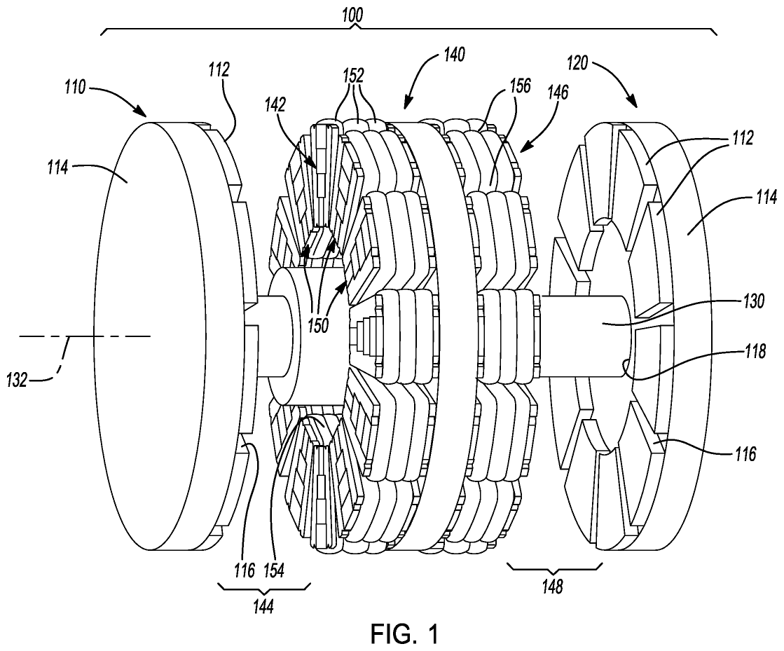

In various aspects, the present disclosure pertains to hybrid stator cores for axial flux electric machines. It will be appreciated that the concepts apply not only to axial flux motors that generate mechanical energy from electrical energy, but also to axial flux generators that can generate electrical energy from mechanical energy. A non-limiting example of an electric machine in the form of an axial flux motor 100, also known as a pancake motor, is shown in FIG. 1. The motor 100 has a first rotor 110 and a second rotor 120 both connected to and configured to rotate about a rotor shaft 130. Both the first and second rotors 110, 120 have an annular or disk shape with a centrally disposed aperture 118. The rotor shaft 130 passes through the centrally disposed aperture 118. The rotor shaft defines a rotational axis 132 about which the rotor turns.

A stator 140 is disposed between the first rotor 110 and the second rotor 120. The stator 140 may have an annular or disk shape. The stator 140 is fixed and stationary, while the first and second rotors 110, 120 rotate during operation with the rotor shaft 130. The first rotor 110 faces a first side 142 of the stator 140 and defines a first air gap 144 therebetween. The second rotor 120 faces a second side 146 of the stator 140 and defines a second air gap 148 therebetween.

Though motor 100 is shown to have a central single stator 140 and two external rotors 110, 120, as appreciated by those of skill in the art, other configurations are also contemplated. These other variations may include those having two stators and a single rotor, or where the electric motor assembly includes additional or fewer rotors and/or stators. The ensuing description also applies to these other embodiments. Further, though not currently shown, the skilled artisan will appreciate that in various aspects, electric motor assemblies may further include a housing and the rotors and stators and shaft may be disposed within the housing. The housing may, in certain aspects, be fixed to a vehicle frame and the shaft may be coupled to a gearbox, for example a reduction gearbox, within the vehicle.

Each of the first rotor 110 and the second rotor 120 can have the same design (facing in opposite directions towards the stator 140) and thus the common components will be described herein. Each of the first rotor 110 and second rotor 120 includes a plurality of permanent magnets 112 affixed to a rotor body 114. The permanent magnets 112 may have alternating polarity. Each permanent magnet 112 defines a channel 116 therebetween, which may extend radially along a face of the respective rotor. In this manner, the permanent magnets 112 and the channel 116 can together define a plurality of magnetic poles.

The stator 140 includes a plurality of stator cores 150 about which a plurality of windings 152 are wrapped. The windings 152 may be made of copper or copper alloys. The stator cores 150 are circumferentially assembled to a stator disc 154 on both the first and second sides 142 and 146 of the stator 140. The stator 140 defines a plurality of slots 156 between adjacent stator cores 150, where the windings 152 may be wound in and through the slots 156. The stator 140 may be fixed and stationary. Although not illustrated, other stator core and winding configurations and technologies as understood in the art are also contemplated. For example, the stator cores 150 may be assembled to the stator disc 154 on only one of the first and second sides 142 and 146 of the stator 140. In another example, the windings 152 may extend over or bridge the slots 156 instead of being wound in and trough the slots 156.

Rotor shaft 130 may pass through a centrally disposed aperture 118 in the stator 140 and be supported by bearings that align the rotors 110, 120 with respect to the stator 140 while allowing rotation of the rotor shaft 130. The windings 152 of the stator 140 may be formed of copper wires or other conductive wires configured to generate a magnetic field when current is applied so as to interact with magnetic fields of the plurality permanent magnets 112 having alternating poles located on the first and second rotors 110, 120. Different regions of the stator 140 may be selectively energized to impart a rotational force on the first and second rotors 110, 120 causing the rotors 110, 120 and the rotor shaft 130 to rotate with respect to the rotational axis 132. The axial flux motor 100 having the single stator 140 and the two rotors 110, 120 is capable of use in high torque applications, including for use in an electric or hybrid vehicle. In such a variation, a housing encasing the motor 100 may be attached to the vehicle frame and at least one output from an end of the rotor shaft 130 is coupled to a reduction gearbox or directly to the vehicle drive wheels. The vehicle application of the axial flux motor 100 is provided as an exemplary embodiment and is not intended to be limiting.

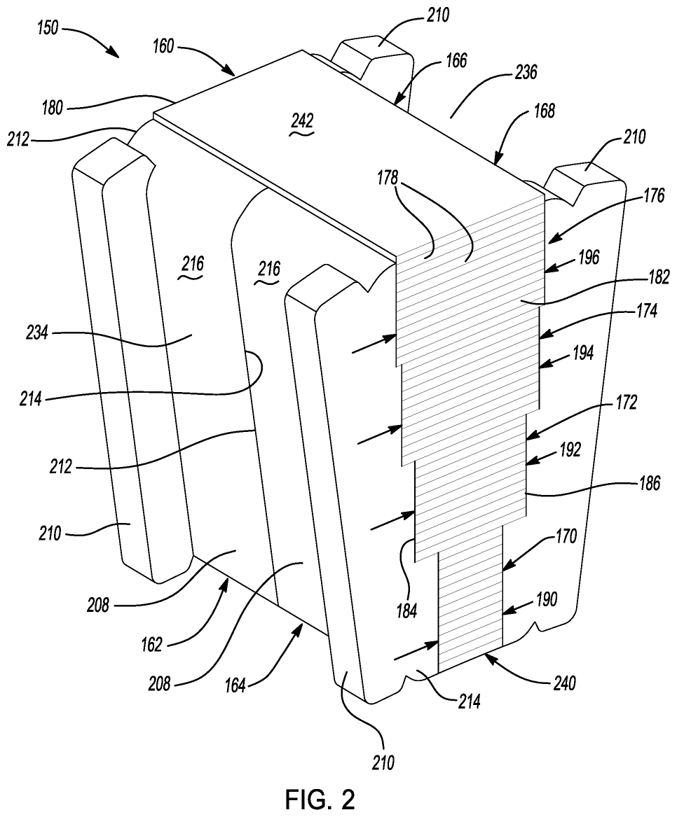

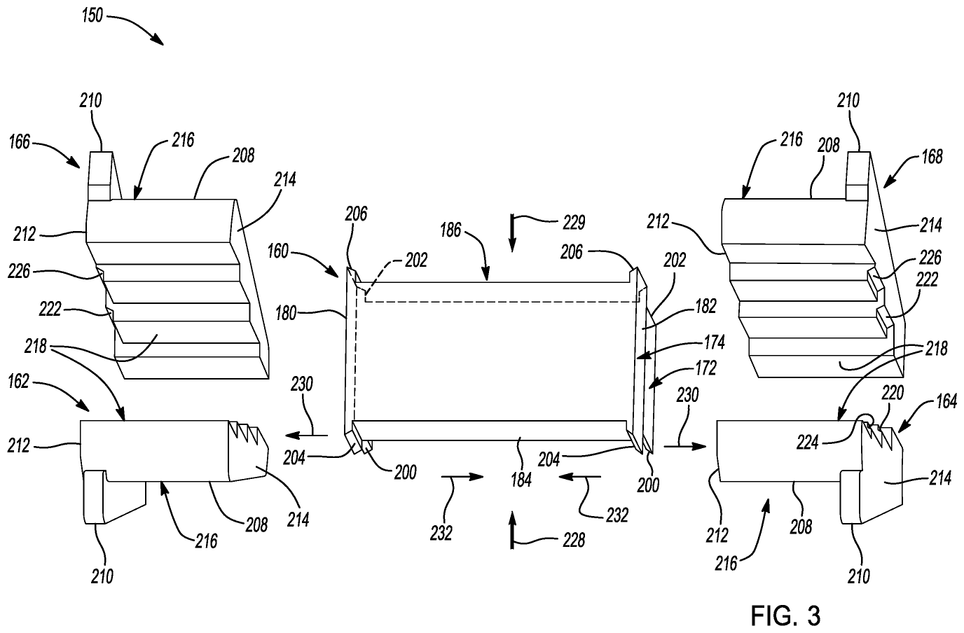

Referring now to FIGS. 2 and 3, the hybrid stator core 150 includes a laminated component 160, a first SMC component 162, a second SMC component 164, a third SMC component 166, and a fourth SMC component 168. The laminated component 160 includes a first block section 170, a second block section 172, a third block section 174, and a fourth block section 176. The second block section 172 is disposed above the first block section 170, the third block section 174 is disposed above the second block section 172, and the fourth block section 176 is disposed above the third block section 174. The first, second, third, and fourth block sections 170, 172, 174, and 176 may be formed together in a single process as a unitary body. Each of the block sections 170, 172, 174, and 176 includes a plurality of sheets or layers 178 of electrical steel. The laminated electrical steel sheets may be punched, optionally annealed, and stacked in manufacturing process to form the laminated component 160.

Each of the block sections 170, 172, 174, 176 has a first end 180, a second end 182 opposite of the first end 180, a first side surface 184, and a second side surface 186 opposite of the first side surface 184. The first and second side surfaces 184 and 186 extend between the first and second ends 180 and 182. The first ends 180 of all the block sections 170, 172, 174, 176 are disposed within one common plane, and the first ends 180 of all the block sections 170, 172, 174, 176 are disposed within another common plane. The planes are parallel to one another and perpendicular to the first and second side surfaces 184 and 186 of the block sections 170, 172, 174, 176.

The first block section 170 has a first width 190 between the first and second ends 180 and 182 thereof. The second block section 172 has a second width 192 between the first and second ends 180 and 182 thereof. The third block section 174 has a third width 194 between the first and second ends 180 and 182 thereof. The fourth block section 176 has a fourth width 196 between the first and second ends 180 and 182 thereof. The second width 192 is greater than the first width 190, the third width 194 is greater than the second width 192, and the fourth width 196 is greater than the third width 194.

In FIG. 3, the first and fourth block sections 170 and 176 are hidden to better illustrate a locking mechanism of the laminated component 160. The locking mechanism includes a first pair of tabs 200 projecting from the first side surface 184 of the second block section 172, a second pair of tabs 202 projecting from the second side surface 186 of the second block section 172, a third pair of tabs 204 projecting from the first side surface 184 of the third block section 174, and a fourth pair of tabs 206 projecting from the second side surface 186 of the third block section 174. The tabs 200, 202 may be integrally formed with the second block section 172, and the tabs 204, 206 may be integrally formed with the third block section 174. Each pair of the tabs 200, 204 hold the first and second SMC components 162 and 164 therebetween, and each pair of the tabs 202, 206 hold the third and fourth SMC components 166 and 168 therebetween.

One of the tabs 200 projects from the first side surface 184 of the second block section 172 adjacent to the first end 180 thereof, and the other tab 200 projects from the first side surface 184 of the second block section 172 adjacent to the second end 182 thereof. One of the tabs 202 projects from the second side surface 186 of the second block section 172 adjacent to the first end 180 thereof, and the other tab 202 projects from the second side surface 186 of the second block section 172 adjacent to the second end 182 thereof. One of the tabs 204 projects from the first side surface 184 of the third block section 174 adjacent to the first end 180 thereof, and the other tab 204 projects from the first side surface 184 of the third block section 174 adjacent to the second end 182 thereof. One of the tabs 206 projects from the second side surface 186 of the third block section 174 adjacent to the first end 180 thereof, and the other tab 206 projects from the second side surface 186 of the third block section 174 adjacent to the second end 182 thereof.

SMC powders comprise a soft magnetic material, the surface of which may be covered with an electrically insulating layer. These powders are consolidated to form SMC components by means of pressing or consolidation. Thus, the SMC components 162, 164, 166, 168 can be readily formed into a variety of different and complex shapes. However, SMC components can generate undesirable eddy currents and may have increased hysteresis when incorporated into a stator of an axial flux motor. Combining the laminate component 160 with the SMC components 162, 164, 166, 168 enables forming the hybrid stator core 150 into a variety of shapes without generating undesirable eddy currents or increased hysteresis.

Each of the SMC components 162, 164, 166, 168 includes a main body 208 and a flange 210 projecting therefrom. The main body 208 has first end 212, a second end 214 opposite of the first end 212, an angled surface 216, and a stepped surface 218 opposite of the angled surface 216. The angled and stepped surfaces 216 and 218 extend between the first and second ends 212 and 214. The flange 210 projects from the stepped surface 218 adjacent to the first or second end 212 or 214 of the main body 208. As best shown in FIG. 3, the stepped surfaces 218 of the first and second SMC components 162 and 164 define first and second pairs of grooves 220 and 222, and the stepped surfaces 218 of the third and fourth SMC components 166 and 168 define third and fourth pairs of grooves 224 and 226. The grooves 220 receive the tabs 200, the grooves 222 receive the tabs 202, the grooves 224 receive the tabs 204, and the grooves 226 receive the tabs 206.

In the implementation shown in FIG. 3, the stepped surfaces 218 of the first, second, third, and fourth SMC components 162, 164, 166, and 168 do not define any grooves for receiving tabs projecting from the first or fourth block sections 170 or 176. Thus, in that implementation, the first and fourth block sections 170 and 176 may not have any tabs projecting from the first and second side surfaces 184 and 186 thereof. In other implementations, the first and fourth block sections 170 and 176 may have tabs projecting from the first and second side surfaces 184 and 186 thereof, and the stepped surfaces 218 of the first, second, third, and fourth SMC components 162, 164, 166, and 168 may define grooves for receiving such tabs.

During assembly of the hybrid stator core 150, the first and second SMC components 162 and 164 are moved toward the laminated component 160 in a first direction 228 until the stepped surfaces 218 of the first and second SMC components 162 and 164 abut the first side surfaces 184 of the block sections 170, 172, 174, 176. Similarly, the third and fourth SMC components 166 and 168 are moved toward the laminated component 160 in a second direction 229 until the stepped surfaces 218 of third and fourth SMC components 166 and 168 abut the second side surfaces 186 of the block sections 170, 172, 174, 176. As the SMC components 162, 164, 166, 168 are moved toward the laminated component 160, the tabs 200, 202, 204, 206 of the laminated component 160 are received in the grooves 220, 222, 224, 226 of the SMC components 162, 164, 166, 168. The tabs 200, 202, 204, 206 may have beveled edges as shown to make it easier to insert the tabs 200, 202, 204, 206 into the grooves 220, 222, 224, 226.

Each pair of the tabs 200, 204 may hold the first and second SMC components 162 and 164 therebetween using a snap fit, and each pair of the tabs 202, 206 may hold the third and fourth SMC components 166 and 168 therebetween using a snap fit. For example, prior to assembly, the distance between the tabs 200 projecting from the second block section 172 may be less than the distance between the grooves 220 in the first and second SMC components 162 and 164 when the second end 214 of the first SMC component 162 abuts the first end 212 of the second SMC component 164. Thus, during assembly, the tabs 200 may flex in an outward direction 230 to enable inserting the first and second SMC components 162 and 164 between the tabs 200. Then, when the tabs 200 are in the grooves 220, the tabs 200 may apply a biasing force in an inward direction 232 that retains the first and second SMC components 162 and 164 between the tabs 200.

When the first and second SMC components 162 and 164 are held between the tabs 200 and between the tabs 204, the second end 214 of the first SMC component 162 abuts the first end 212 of the second SMC component 164. Similarly, when the third and fourth SMC components 166 and 168 are held between the tabs 202 and between the tabs 206, the second end 214 of the third SMC component 166 abuts the first end 212 of the fourth SMC component 168. The first and second SMC components 162 and 164 may be held together using both the tabs 200, 204 and adhesive applied between the second end 214 of the first SMC component 162 and the first end 212 of the second SMC component 164. Similarly, the third and fourth SMC components 162 and 164 may be held together using both the tabs 202, 206 and adhesive applied between the second end 214 of the third SMC component 166 and the first end 212 of the fourth SMC component 168.

When the hybrid stator core 150 is fully assembled as shown in FIG. 2, the flanges 210 of the first and second SMC components 162 and 164 define a recessed region 234 therebetween, and the flanges 210 of the third and fourth SMC components 166 and 168 define a recessed region 236 therebetween. The recessed regions 234, 236 receive the windings 152 as shown in FIG. 1. The windings 152 are wrapped around a perimeter of the hybrid stator core 150 formed by a bottom surface 240 of the first block section 170, a top surface 242 of the fourth block section 176, and the angled surfaces 216 of the first, second, third, and fourth SMC sections 162, 164, 166, and 168. The perimeter of the hybrid stator core 150 has a trapezoidal shape. A cross-section of hybrid stator core 150 disposed with a plane perpendicular to the first and second side surfaces of the block sections 170, 172, 174, 176 also has a trapezoidal shape.

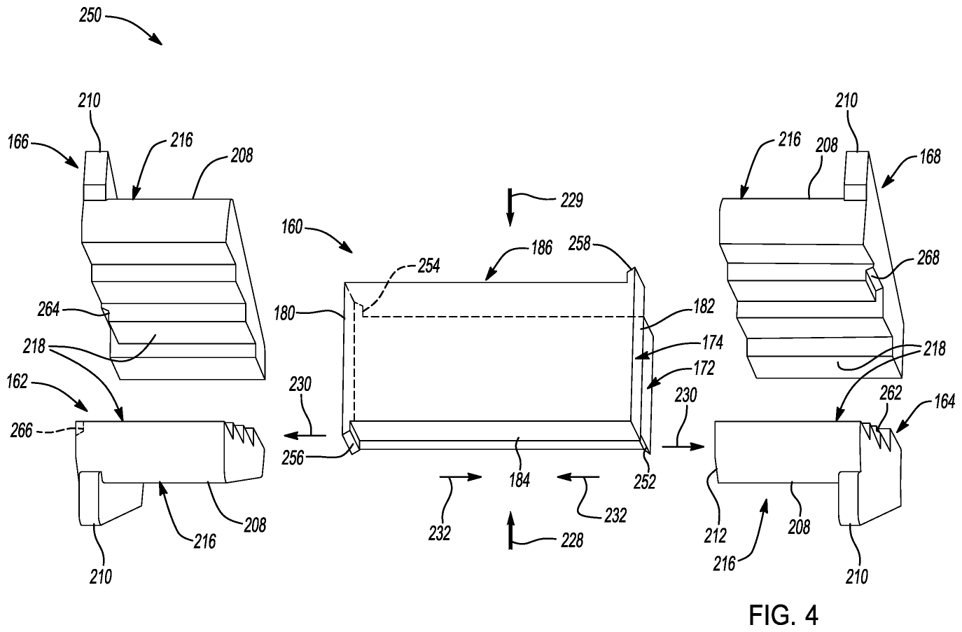

FIG. 4 shows a hybrid stator core 250 that is substantially similar to the hybrid stator core 150 except for the locking mechanism of the laminated component 160. As in FIG. 3, the first and fourth block sections 170 and 176 are hidden in FIG. 4 to better illustrate the locking mechanism of the laminated component 160. The locking mechanism includes only one tab 252 projecting from the first side surface 184 of the second block section 172, only one tab 254 projecting from the second side surface 186 of the second block section 172, only one tab 256 projecting from the first side surface 184 of the third block section 174, and only one tab 258 projecting from the second side surface 186 of the third block section 174. Similarly, the first and second SMC components 162 and 164 define only one groove 262 for receiving the tab 252 and only one groove 264 for receiving the tab 254, and the third and fourth SMC components 166 and 168 define only one groove 266 for receiving the tab 256 and only one groove 268 for receiving the tab 258.

The tab 252 projects from the first side surface 184 of the second block section 172 adjacent to the second end 182 thereof. The tab 254 projects from the second side surface 186 of the second block section 172 adjacent to the first end 180 thereof. The tab 256 projects from the first side surface 184 of the third block section 174 adjacent to the first end 180 thereof. The tab 258 projects from the second side surface 186 of the third block section 174 adjacent to the second end 182 thereof. The tabs 252, 256 hold the first and second SMC components 162 and 164 therebetween. The tabs 254, 258 hold the third and fourth SMC components 166 and 168 therebetween.

Forming the laminated component 160 with the tabs 252, 254, 256, 258 projecting from the first and second side surfaces 184 or 186 of the second and third block sections 172 and 174 adjacent to only one end thereof may simplify manufacturing. For example, during assembly of the hybrid stator component 250, the first and second SMC components 162 and 164 may be moved toward the laminated component 160 in the outward or inward directions 130 or 132 instead of the first direction 228. Similarly, the third and fourth SMC components 166 and 168 are moved toward the laminated component 160 in the outward or inward directions 130 or 132 instead of the first direction 228.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A hybrid stator core for an axial flux electric machine, the hybrid stator core comprising:
a laminated component including a first block section, a first tab, and a second tab, the first block section having a first end, a second end opposite the first end, a first side surface extending between the first and second ends, and a second side surface opposite the first side surface, the first tab projecting from the first side surface adjacent to the first end of the first block section, the second tab projecting from the first side surface adjacent to the second end of the first block section; and
at least one soft magnetic composite (SMC) component configured to abut the first side surface of the first block section, wherein the first and second tabs are configured to hold the at least one SMC component therebetween.

2. The hybrid stator core of claim 1 wherein:
the at least one SMC component includes a first SMC component and a second SMC component;
the first SMC component is configured to abut the first side surface of the first block section adjacent to the first end thereof; and
the second SMC component is configured to abut the first side surface of the first block section adjacent to the second end thereof.

3. The hybrid stator core of claim 2 wherein:
the first SMC component defines a first groove configured to receive the first tab; and
the second SMC component defines a second groove configured to receive the second tab.

4. The hybrid stator core of claim 2 wherein:
the laminated component further includes a third tab and a fourth tab, the third tab projecting from the second side surface of the first block section adjacent to the first end thereof, the fourth tab projecting from the second side surface adjacent to the second end thereof; and
the hybrid stator core further comprises:
a third SMC component configured to abut the second side surface of the first block section adjacent to the first end thereof; and
a fourth SMC component configured to abut the second side surface of the first block section adjacent to the second end thereof, wherein the third and fourth tabs are configured to hold the third and fourth SMC components therebetween.

5. The hybrid stator core of claim 4 wherein the hybrid stator core has a trapezoidal cross section within a plane perpendicular to the first and second side surfaces of the first block section.

6. The hybrid stator core of claim 1 wherein:
the laminated component further includes a second block section, a third tab, and a fourth tab, the second block section adjoining the first block section and having a first end, a second end opposite the first end, and a first side surface extending between the first and second ends, the third tab projecting from the first side surface adjacent to the first end of the second block section, the fourth tab projecting from the first side surface adjacent to the second end of the second block section; and
the third and fourth tabs are configured to hold the at least one SMC component therebetween.

7. The hybrid stator core of claim 6 wherein:
the first block section has a first width between the first and second ends thereof;
the second block section is disposed above the first block section and has a second width between the first and second ends thereof; and
the second width is greater than the first width.

8. A hybrid stator core for an axial flux electric machine, the hybrid stator core comprising:
a laminated component including a first block section, a second block section, a first tab, and a second tab, each of the first and second block sections having a first end, a second end opposite the first end, a first side surface extending between the first and second ends, and a second side surface opposite the first side surface, the first tab projecting from the first side surface of the first block section adjacent to the first end thereof, the second tab projecting from the first side surface of the second block section adjacent to the second end thereof; and
at least one SMC component configured to abut the first side surfaces of the first and second block sections, wherein the first and second tabs are configured to hold the at least one SMC component therebetween.

9. The hybrid stator core of claim 8 wherein:
the at least one SMC component includes a first SMC component and a second SMC component;
the first SMC component is configured to abut the first side surface of the first block section adjacent to the first end thereof; and
the second SMC component is configured to abut the first side surface of the first block section adjacent to the second end thereof.

10. The hybrid stator core of claim 9 wherein:
the first SMC component defines a first groove configured to receive the first tab; and
the second SMC component defines a second groove configured to receive the second tab.

11. The hybrid stator core of claim 9 wherein:
the laminated component further includes a third tab and a fourth tab, the third tab projecting from the second side surface of one of the first and second block sections adjacent to the first end thereof, the second tab projecting from the second side surface of the other one of the first and second block sections adjacent to the second end thereof; and
the hybrid stator core further comprises:
a third SMC component configured to abut the second side surfaces of the first and second block sections adjacent to the first ends thereof; and
a fourth SMC component configured to abut the second side surfaces of the first and second block sections adjacent to the second ends thereof, wherein the third and fourth tabs are configured to hold the third and fourth SMC components therebetween.

12. The hybrid stator core of claim 8 wherein:
the laminated component is free of any tab projecting from the first side surface of the first block section adjacent to the second end thereof; and
the laminated component is free of any tab projecting from the first side surface of the second block section adjacent to the first end thereof.

13. The hybrid stator core of claim 8 wherein:
the first block section has a first width between the first and second ends thereof;
the second block section is disposed above the first block section and has a second width between the first and second ends thereof; and
the second width is greater than the first width.

14. The hybrid stator core of claim 13 wherein:
the laminated component further includes a third block section disposed below the first block section and a fourth block section disposed above the second block section, each of the third and fourth block sections having a first end and a second end opposite the first end;
the first ends of the first, second, third, and fourth block sections are disposed within a first common plane;
the second ends of the first, second, third, and fourth block sections are disposed within a second common plane;
the third block section has a third width between the first and second ends thereof;
the fourth block section has a fourth width between the first and second ends thereof;
the third width is less than the first width; and
the fourth width is greater than the second width.

15. A hybrid stator core for an axial flux electric machine, the hybrid stator core comprising:
a laminated component including a first block section, a second block section, a first tab, a second tab, a third tab, and a fourth tab, each of the first and second block sections having a first end, a second end opposite the first end, a first side surface, and a second side surface opposite the first side surface, the first and second side surfaces extending between the first and second ends, the first tab projecting from the first side surface of one of the first and second block sections adjacent to the first end thereof, the second tab projecting from the first side surface of one of the first and second block sections adjacent to the second end thereof, the third tab projecting from the second side surface of one of the first and second block sections adjacent to the first end thereof, the fourth tab projecting from the second side surface of one of the first and second block sections adjacent to the second end thereof;
a first SMC component configured to abut the first side surfaces of the first and second block sections adjacent to the first ends thereof;
a second SMC component configured to abut the first side surfaces of the first and second block sections adjacent to the second ends thereof, wherein the first and second tabs are configured to hold the first and second SMC components therebetween;
a third SMC component configured to abut the second side surfaces of the first and second block sections adjacent to the first ends thereof; and
a fourth SMC component configured to abut the second side surfaces of the first and second block sections adjacent to the second ends thereof, wherein the third and fourth tabs are configured to hold the third and fourth SMC components therebetween.

16. The hybrid stator core of claim 15 wherein:
the first tab projects from the first side surface of the first block section adjacent to the first end thereof;
the second tab projects from the first side surface of the first block section adjacent to the second end thereof;
the third tab projects from the second side surface of the first block section adjacent to the first end thereof; and
the fourth tab projects from the second side surface of the first block section adjacent to the second end thereof.

17. The hybrid stator core of claim 15 wherein:
the first tab projects from the first side surface of the first block section adjacent to the first end thereof;
the second tab projects from the first side surface of the second block section adjacent to the second end thereof;
the third tab projects from the second side surface of the first block section adjacent to the first end thereof;
the fourth tab projects from the second side surface of the second block section adjacent to the second end thereof; and
the laminated component is free of any tab projecting any one of:
the first side surface of the first block section adjacent to the second end thereof;
the first side surface of the second block section adjacent to the first end thereof;
the first side surface of the first block section adjacent to the second end thereof; and
the first side surface of the second block section adjacent to the first end thereof.

18. The hybrid stator core of claim 15 wherein:
the first SMC component defines a first groove configured to receive the first tab and a second groove configured to receive the third tab; and
the second SMC component defines a third groove configured to receive the second tab and a fourth groove configured to receive the fourth tab.

19. The hybrid stator core of claim 15 wherein:
the laminated component further includes a third block section disposed below the first block section and a fourth block section disposed above the second block section, each of the third and fourth block sections having a first end and a second end opposite the first end;
the first ends of the first, second, third, and fourth block sections are disposed within a first common plane;
the second ends of the first, second, third, and fourth block sections are disposed within a second common plane;
the first block section has a first width between the first and second ends thereof;
the second block section is disposed above the first block section and has a second width between the first and second ends thereof;
the third block section has a third width between the first and second ends thereof;
the fourth block section has a fourth width between the first and second ends thereof;
the second width is greater than the first width;
the third width is less than the first width; and
the fourth width is greater than the second width.

20. The hybrid stator core of claim 19 wherein:
each of the first, second, third, and fourth SMC sections has a stepped surface and an angled surface opposite the stepped surface;
the stepped surfaces of the first and second SMC sections are configured to abut the first side surfaces of the first, second, third, and fourth block sections;
the stepped surfaces of the third and fourth SMC sections are configured to abut the second side surfaces of the first, second, third, and fourth block sections;
a bottom surface of the third block section, a top surface of the fourth block section, and the angled surfaces of the first, second, third, and fourth SMC sections form a perimeter of the hybrid stator core configured to have a winding wrapped thereabout; and
the perimeter of the hybrid stator core has a trapezoidal shape.
